(19) United States
(12) Patent Application Publication
(10) Pub. No.: US 2025/0320743 A1
(43) Pub. Date: Oct. 16, 2025

(54) CUMULATIVE DISPLACEMENT GAUGE AND VIBRATION CONTROL DAMPER

(71) Applicant: R KIKAI CO., LTD., Saitama, Tokyo (JP)

(72) Inventor: Tsutomu TAKAHASHI, Saitama, Tokyo (JP)

(73) Assignee: R KIKAI CO., LTD., Saitama, Tokyo (JP)

(21) Appl. No.: 18/868,865

(22) PCT Filed: Mar. 22, 2023
(86) PCT No.: PCT/JP2023/011106

§ 371 Date: Nov. 25, 2024

(30) Foreign Application Priority Data
Jun. 29, 2022 (JP) 2022-104343

(51) Int. Cl. E04H 9/02; F16F 7/12; G01B 5/30

(52) U.S. Cl. CPC E04H 9/027; E04H 9/021; F16F 7/12; G01B 5/30

(57) ABSTRACT

A cumulative displacement gauge measuring the amount of cumulative displacement of a second member relative to a first member, and comprising: a first rack that is attached to the second member and extends in the direction of displacement of the second member; a second rack that is attached to the second member at a prescribed distance from the first rack and extends in the direction of displacement of the second member; a pinion that is located between the first rack and the second rack and is rotatably supported by the first member; a location control member the controls the locations of the first rack and the second rack such that when the first rack has been displaced in a first direction, the first rack meshes with the pinion and the second rack is distanced from the pinion, and when the second rack has been displaced in a second direction, the second rack meshes with the pinion and the first rack is distanced from the pinion; and an output member that outputs the amount of cumulative displacement, which is measured from the amount of rotation of the pinion.

### TECHNICAL FIELD

The present invention relates to a cumulative displacement gauge that measures a cumulative displacement caused by vibration of a building, and a vibration control damper provided with the cumulative displacement gauge.

### BACKGROUND ART

With regard to civil engineering structures such as bridges, and with regard to architectural structures such as buildings, etc., a method has been known that places a vibration control damper between structures and reduces loads and/or deformation applied to members of the structures by means of energy absorption effect of the damper.

There are frequently various vibration control dampers that use steel material. One of which is called as a buckling restraining damper (damper brace). This type of damper is called as a hysteresis damper, that absorbs energy by means of plastic deformation associated with telescopic movement of a shaft member, and that is provided with the shaft member, which telescopically moves by means of shaft load applied in an axial direction, and also with a stiffening member, into which the shaft member is inserted, for preventing buckling of the shaft member. For the purpose of exerting stable energy absorption ability, the design and safety control of hysteresis dampers are executed with reference to two indexes, namely, a maximum displacement amount of the shaft member relative to the stiffening member, and a cumulative displacement amount for displaying fatigue durability. Thus, there is a displacement display device as described in Patent Document 1, which measures safety (durability) of a vibration control damper by seeing from an exterior appearance, in a case of occurrence of earthquake.

### CITATION LIST

### Patent Literature

Patent Literature 1: JP Patent No. 6546561

### SUMMARY OF INVENTION

### Technical Problem

However, with reference to the displacement display device as described in Patent Document 1, although no electric power is required, the configuration is complex because, a forward/reverse linear movement is firstly converted into a forward/reverse rotative movement, and then, the forward/reverse rotative movement is converted into a unidirectional rotative movement. Moreover, with regard to a device for measuring a cumulative displacement amount by using electric power, it is impossible to measure the cumulative displacement amount, in a location where a commercial power source may not be used for a long period of time, or in a location where a replacement of power source, such as a battery, may not be made easily.

In the light of the above problems, it is an object of the present invention to provide a mechanical-type, simple-structured cumulative displacement gauge, and a vibration control damper provided with that cumulative displacement gauge, that enable measurement of cumulative displacement without requiring electric power.

### Solution to Problem

A cumulative displacement gauge according to the present invention is a cumulative displacement gauge for measuring a cumulative displacement amount of a second member relative to a first member. The cumulative displacement gauge includes a first rack attached to the second member and extending in a displacement direction in which the second member displaces, and a second rack attached to the second member with having a predetermined distance from the first member and extending in the displacement direction. The cumulative displacement gauge also includes a pinion positioned between the first rack and the second rack, and rotatably supported by the first member. The cumulative displacement gauge also includes a position control member for controlling positions of the first rack and second rack, in a manner that, when the first rack displaces in a first direction, that is a direction along the displacement direction, then, the first rack meshes with the pinion and also the second rack separates from the pinion, and when the second rack displaces in a second direction, that is a direction opposite to the first direction, then, the second rack meshes with the pinion and also the first rack separates from the pinion. The cumulative displacement gauge also includes an output member for outputting the cumulative displacement amount measured from a rotation amount of the pinion. The cumulative displacement gauge is characterized in that, when the first rack displaces in the first direction, the first rack causes rotation of the pinion in a cumulative rotation direction, and when the second rack displaces in the second direction, the second rack causes rotation of the pinion in the cumulative rotation direction.

The cumulative displacement gauge according to the present invention is that, with regard to teeth of the first rack and teeth of the second rack, a tooth surface in the first direction and a tooth surface in the second direction are in different shapes.

The cumulative displacement gauge according to the present invention is that, with regard to the tooth of the first rack, the tooth surface in the first direction is a concave surface meshing with a tooth of the pinion, and with regard to the tooth of the second rack, the tooth surface in the second direction is a concave surface meshing with the tooth of the pinion.

The cumulative displacement gauge according to the present invention is that, with regard to the tooth of the first rack, the tooth surface in the second direction is an inclined surface having a predetermined angle relative to the displacement direction, and with regard to the tooth of the second rack, the tooth surface in the first direction is an inclined surface having a predetermined angle relative to the displacement direction.

The cumulative displacement gauge according to the present invention is that the first rack and the second rack respectively include a plurality of long holes inclined relative to the displacement direction, and are respectively attached to the second member via the position control member, and the position control member includes a plurality of bosses respectively inserted into each of the long holes, and controls a position of the first rack and a position of the second rack respectively relative to the pinion by movement of the bosses inside the long holes associated with displacement of the second member in the displacement direction.

The cumulative displacement gauge according to the present invention is that number of the teeth of the pinion is an odd number.

The cumulative displacement gauge according to the present invention is that the output member is a display member for displaying the cumulative displacement amount.

The cumulative displacement gauge according to the present invention further includes a first connection section for connecting one end in the displacement direction of the first rack with one end in the displacement direction of the second rack, and a second connection section for connecting another end in the displacement direction of the first rack with another end in the displacement direction of the second rack.

The cumulative displacement gauge according to the present invention is that the first member is a stiffening member of a vibration control damper for dampening vibration of a structure, and the second member is a shaft member of the vibration control damper.

A vibration control damper according to the present invention is a vibration control damper for dampening vibration of a structure. The vibration control damper includes a shaft member displaced by the vibration, a stiffening member for preventing buckling of the shaft member, and the cumulative displacement gauge according to the present invention for measuring displacement of the shaft member relative to the stiffening member.

The vibration control damper according to the present invention is that, with regard to the tooth of the first rack of the cumulative displacement gauge, the tooth surface in the first direction is a concave surface meshing with a tooth of the pinion, and with regard to the tooth of the second rack of the cumulative displacement gauge, the tooth surface in the second direction is a concave surface meshing with the tooth of the pinion.

The vibration control damper according to the present invention is that, with regard to the tooth of the first rack of the cumulative displacement gauge, the tooth surface in the second direction is an inclined surface having a predetermined angle relative to the displacement direction, and with regard to the tooth of the second rack of the cumulative displacement gauge, the tooth surface in the first direction is an inclined surface having a predetermined angle relative to the displacement direction.

The vibration control damper according to the present invention is that the first rack and the second rack of the cumulative displacement gauge respectively include a plurality of long holes inclined relative to the displacement direction, and are respectively attached to the second member via the position control member. The vibration control damper is also that the position control member of the cumulative displacement gauge includes a plurality of bosses respectively inserted into each of the long holes, and controls a position of the first rack and a position of the second rack respectively relative to the pinion by movement of the bosses inside the long holes associated with displacement of the second member in the displacement direction.

The vibration control damper according to the present invention is that number of the teeth of the pinion of the cumulative displacement gauge is an odd number.

The vibration control damper of the present invention is that the output member of the cumulative displacement gauge is a display member for displaying the cumulative displacement amount.

The vibration control damper according to the present invention further includes a first connection section for connecting one end in the displacement direction of the first rack with one end in the displacement direction of the second rack of the cumulative displacement gauge, and a second connection section for connecting another end in the displacement direction of the first rack with another end in the displacement direction of the second rack of the cumulative displacement gauge.

### Advantageous Effects of Invention

According to the present invention, it is possible to provide a mechanical-type, simple-structured cumulative displacement gauge, and a vibration control damper provided with that cumulative displacement gauge, that enable measurement of cumulative displacement without requiring electric power.

### BRIEF DESCRIPTION OF DRAWINGS

FIG. 1 is a view showing a configuration of a vibration control damper according to an embodiment.

FIG. 2 is a front view showing a configuration of a cumulative displacement gauge according to the embodiment.

FIG. 3 is a plan view showing a configuration of the cumulative displacement gauge according to the embodiment.

FIG. 4 is a view showing a configuration of a rack-and-pinion section according to the embodiment, showing a state in which a first rack and a pinion mesh with each other.

FIG. 5 is a view showing a configuration of the rack-and-pinion section according to the embodiment, showing a state in which a second rack and the pinion mesh with each other.

FIG. 6 is an expanded view showing a state in which a tooth of the first rack and a tooth of the pinion mesh with each other according to the embodiment.

FIG. 7 is an expanded view showing a state in which a tooth of the second rack and a tooth of the pinion mesh with each other according to the embodiment.

FIG. 8 is a plan view and a sectional view showing a configuration of a position control member according to the embodiment.

FIG. 9 is a view showing a state in which the vibration control damper according to the embodiment is attached to a bridge.

### DESCRIPTION OF EMBODIMENT

Now, a cumulative displacement gauge, and a vibration control damper provided with the cumulative displacement gauge, according to an embodiment of the present invention, will be explained in detail, with reference to drawings attached hereto. However, it should be noted that, the drawings are merely illustrated schematically, and relation between thickness and plane dimension, or thickness proportion of each of layer, etc., are different from those of actual ones. Therefore, specific thickness, dimension, etc., should be determined with reference to the detailed explanation as described below. Moreover, it is needless to say that, there may be some parts in drawings, which are illustrated in different dimension relations or proportions between each other.

Moreover, it should also be understood that embodiments below merely explain devices and/or methods in order to substantiate technical ideas of the present invention, and these technical ideas are not limited to the materials, shapes, structures, configurations, etc., of elements described below. It should also be understood that various modifications of the technical ideas of the present invention may occur within the technical scope of appended Claims.

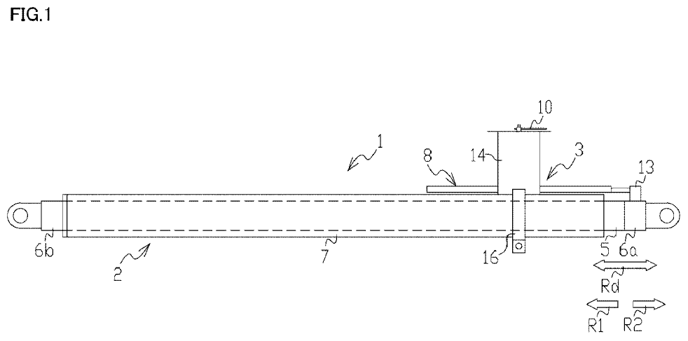

FIG. 1 is a view showing an overall configuration of a vibration control damper according to the embodiment. A vibration control damper 1 is an axial-yield type of vibration control damper, which dampens vibration of structures, for example civil engineering structures such as bridges, or architectural structures such as buildings, and is provided, as illustrated in FIG. 1, with a damper body 2 and a cumulative displacement gauge 3.

The damper body 2 is provided with: a shaft member 5, which absorbs dampens, by means of plastic deformation, axial loads of compression and tension applied thereto in an axial direction (the right/left direction of the sheet of FIG. 1); a pair of structure connecting members 6a, 6b, respectively provided at each end of the shaft member 5 in the axial direction; and a stiffening member 7 into which the shaft member 5 is inserted.

The shaft member 5 is formed by a steel pipe, made of ordinary steel or low-yield-point steel, having hysteresis damping characteristics (energy damping characteristics associated with plastic deformation). The shaft member 5 displaces due to vibration, and yields, by moving telescopically, to the axial load applied in the axial direction. The stiffening member 7 is a member for preventing buckling of the shaft member 5 when a compression load of the axial direction is applied to the shaft member 5, and is formed, for example, in a cylindrical shape. The pair of structure connecting members 6a, 6b are used as joints when attaching the vibration control damper 1 to civil engineering structures such as bridges, arch bridges, water gates, and box culverts, and architectural structures such as buildings, towers, and warehouses. With regard to the pair of structure connecting members 6a, 6b, there may be a bolt-joint type or a pin-joint type, and in the present embodiment, a pin-joint type is adopted.

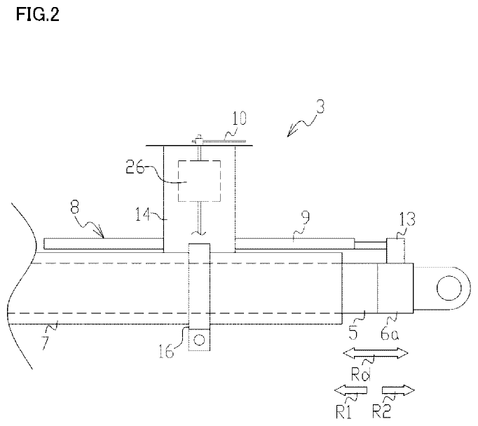

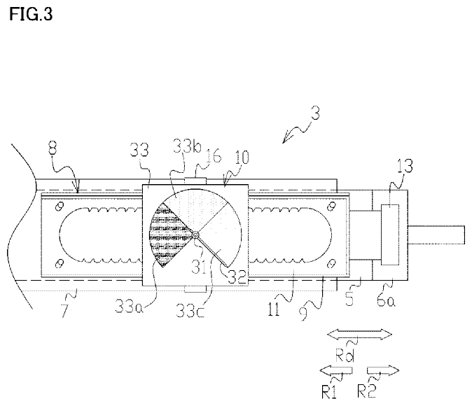

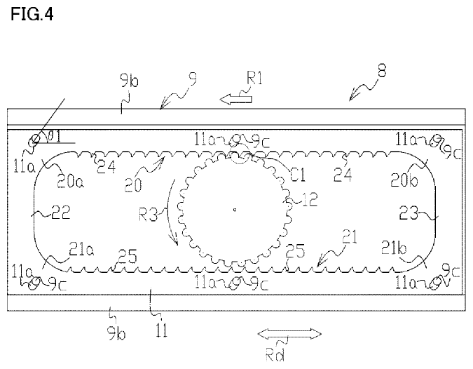

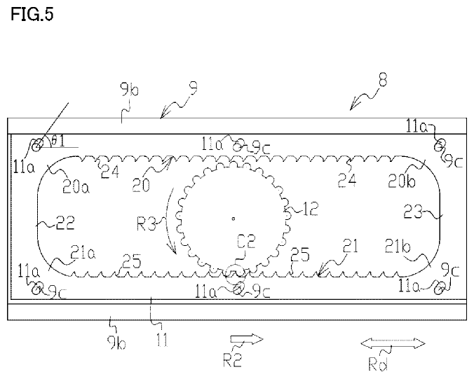

FIG. 2 is a front view showing a configuration of a cumulative displacement gauge 3 according to the embodiment, and FIG. 3 is a plan view thereof. The cumulative displacement gauge 3 is a cumulative displacement gauge that measures cumulative displacement amount of a second member (the shaft member 5) relative to a first member (the stiffening member 7), and is provided, as illustrated in FIG. 2 and FIG. 3, with a rack-and-pinion section 8, a cumulative displacement amount display member 10, and a gear box 26. The rack-and-pinion section 8 converts a relative displacement, which occurs between the stiffening member 7 and the shaft member 5 (the structure connecting member 6a), into a rotative movement in a single direction (a cumulative rotation direction R3 as illustrated in FIG. 4 and FIG. 5). The cumulative displacement amount display member 10 displays a cumulative displacement amount, by means of rotation in a single direction (a cumulative rotation direction R3) obtained from a pinion 12 of the rack-and-pinion section 8 (see FIG. 4). The gear box 26 is located at a position between an input shaft, which is connected with the pinion 12, and an output shaft, which is connected with the cumulative displacement amount display member 10, and accommodates a gear for reducing rotation speed of the input shaft. A case 14 accommodates the pinion 12 and the gear box 26, and is fixed on the outer periphery of the stiffening member 7 by a fixing belt 16.

FIG. 4 and FIG. 5 are views showing a configuration of the rack-and-pinion section 8. Note that, FIG. 4 is a view showing a state in which a first rack 20 of a rack member 11 and the pinion 12 mesh with each other, and FIG. 5 is a view showing a state in which a second rack 21 of the rack member 11 and the pinion 12 mesh with each other. As illustrated in FIG. 4 and FIG. 5, the rack-and-pinion section 8 is provided with the rack member 11, the pinion 12, and a position control member 9. As illustrated in FIG. 2, the rack member 11 and the position control member 9 are placed in a state extending in an axial direction of the shaft member 5 along an outer periphery of the stiffening member 7 from one end fixed on the structure connecting member 6a via a connection member 13, and in a state penetrating through the case 14.

The rack member 11 is provided with the first rack 20 and the second rack 21. The first rack 20 is attached to the shaft member 5 via the position control member 9, the connection member 13, and the structure connecting member 6a, and extends in a displacement direction Rd that the shaft member 5 is displaced. The second rack 21 is attached to the shaft member 5 via the position control member 9, the connection member 13, and the structure connecting member 6a, with a predetermined distance from the first rack 20 in a direction orthogonal to the displacement direction Rd, and extends in the displacement direction Rd. One end 20a of the first rack 20 in the displacement direction Rd, and one end 21a of the second rack 21 in the displacement direction Rd, are connected with each other by a first connection section 22. Another end 20b of the first rack 20 in the displacement direction Rd, and another end 21b of the second rack 21 in the displacement direction Rd, are connected with each other by a second connection section 23.

The rack member 11 has a plurality of (in the present embodiment, six) long holes 11a, respectively inclining relative to the displacement direction Rd. In the present embodiment, the long holes 11a are configured to be positioned, at four corners of the rack member 11, and at either center between the two long holes 11a and 11a along the displacement direction Rd. In the present embodiment, an inclination angle θ1 of the long hole 11a relative to the displacement direction Rd is 54 degrees, but it is sufficient that the inclination angle θ1 is within a range from 36 degrees to 54 degrees. Each of bosses 9c of the position control member 9, which will be described in detail afterwards, is inserted into each of the long holes 11a, respectively.

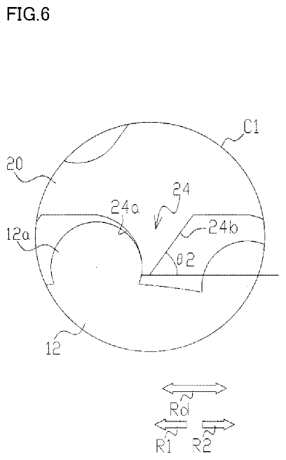

A plurality of teeth 24 is formed in the first rack 20 along the displacement direction Rd. FIG. 6 is an expanded view showing a part surrounded by a circle C1 of FIG. 4. With regard to each of the teeth 24 of the first rack 20, as illustrated in FIG. 6, a tooth surface 24a on a side of a first direction R1 along the displacement direction Rd, and a tooth surface 24b on a side of a second direction R2, which is a direction opposite to the first direction R1, have different shapes. With regard to each of the teeth 24 of the first rack 20, the tooth surface 24a on the side of the first direction R1 is a concave surface meshing with a tooth 12a of the pinion 12, and transmits a linear movement of the rack member 11 to the pinion 12, by meshing of the tooth surface 24a with the tooth 12a of the pinion 12, when the rack member 11 (the first rack 20) moves in the first direction R1. Meanwhile, the tooth surface 24b, on the side of the second direction R2, is an inclined surface having a predetermined angle relative to the displacement direction Rd, and although an inclination angle θ2 of the tooth surface 24b relative to the displacement direction Rd is 54 degrees, it is sufficient that the inclination angle θ2 is within a range from 36 degrees to 54 degrees. Moreover, the inclination angle θ2 of the tooth surface 24b is identical with the inclination angle θ1 of the long hole 11a. When the rack member 11 (the first rack 20) moves in the second direction R2, as illustrated in FIG. 5, the tooth surface 24b do not mesh with the tooth surface 12a of the pinion 12, but repels the tooth surface 12a, and guides the rack member 11 in a direction in which the first rack 20 separates from the pinion 12.

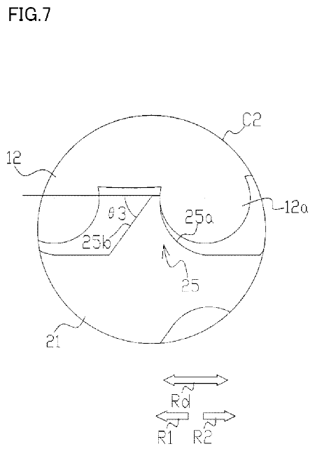

A plurality of teeth 25 is formed in the second rack 21 along the displacement direction Rd. FIG. 7 is an expanded view schematically showing a part surrounded by a circle C2 of FIG. 5. With regard to each of the teeth 25 of the second rack 21, as illustrated in FIG. 7, a tooth surface 25b on the side of the first direction R1, and a tooth surface 25a on the side of the second direction R2, have different shapes. With regard to each of the teeth 25 of the second rack 21, the tooth surface 25a on the side of the second direction R2 is a concave surface meshing with the tooth 12a of the pinion 12, and transmits a linear movement of the rack member 11 to the pinion 12, by meshing of the tooth surface 25a with the tooth 12a of the pinion 12, when the rack member 11 (the second rack 21) moves in the second direction R2. Meanwhile, the tooth surface 25b, on the side of the first direction R1, is an inclined surface having a predetermined angle relative to the displacement direction Rd, and although an inclination angle θ3 of the tooth surface 25b relative to the displacement direction Rd is 54 degrees, it is sufficient that the inclination angle θ3 is within a range from 36 degrees to 54 degrees. Moreover, the inclination angle θ3 of the tooth surface 25b is identical with the inclination angle θ1 of the long hole 11a. When the rack member 11 (the second rack 21) moves in the first direction R1, the tooth surface 25b do not mesh with the tooth surface 12a of the pinion 12, but repels the tooth surface 12a, and guides the rack member 11 in a direction in which the second rack 21 separates from the pinion 12.

As illustrated in FIG. 4 and FIG. 5, the pinion 12 is located at a position between the first rack 20 and the second rack 21. The pinion 12 is rotatably supported by the stiffening member 7, or by the case 14 fixed on the stiffening member 7. The pinion 12 has an odd number of (in the present embodiment, twenty-five) teeth 12a formed therein. Thus, when one of the teeth 12a of the pinion 12 meshes with the tooth 24 of the first rack 20, the tooth 12a, which is the closest to the tooth 25 of the second rack 21, does not interfere with the tooth 25, and when one of the teeth 12a of the pinion 12 meshes with the tooth 25 of the second rack 21, the tooth 12a, which is the closest to the tooth 24 of the first rack 20, does not interfere with the tooth 24.

When the rack member 11 moves in the first direction R1, the pinion 12 does not mesh with the second rack 21 separated from the pinion 12, but meshes with the first rack 20, and the linear movement in the first direction R1 of the rack member 11 is converted into the rotative movement in the cumulative rotation direction R3, and the pinion 12 rotates in the cumulative rotation direction R3. Moreover, when the rack member 11 moves in the second direction R2, the pinion 12 does not mesh with the first rack 20 separated from the pinion 12, but meshes with the second rack 21, and the linear movement in the second direction R2 of the rack member 11 is converted into the rotative movement in the cumulative rotation direction R3, and the pinion 12 rotates in the cumulative rotation direction R3. Thus, wherever the rack member 11 moves in the first direction R1, or in the second direction R2 opposite to the first direction R1, the pinion 12 rotates in a single direction, that is in the cumulative rotation direction R3, and does not rotate in a direction opposite to the cumulative rotation direction R3.

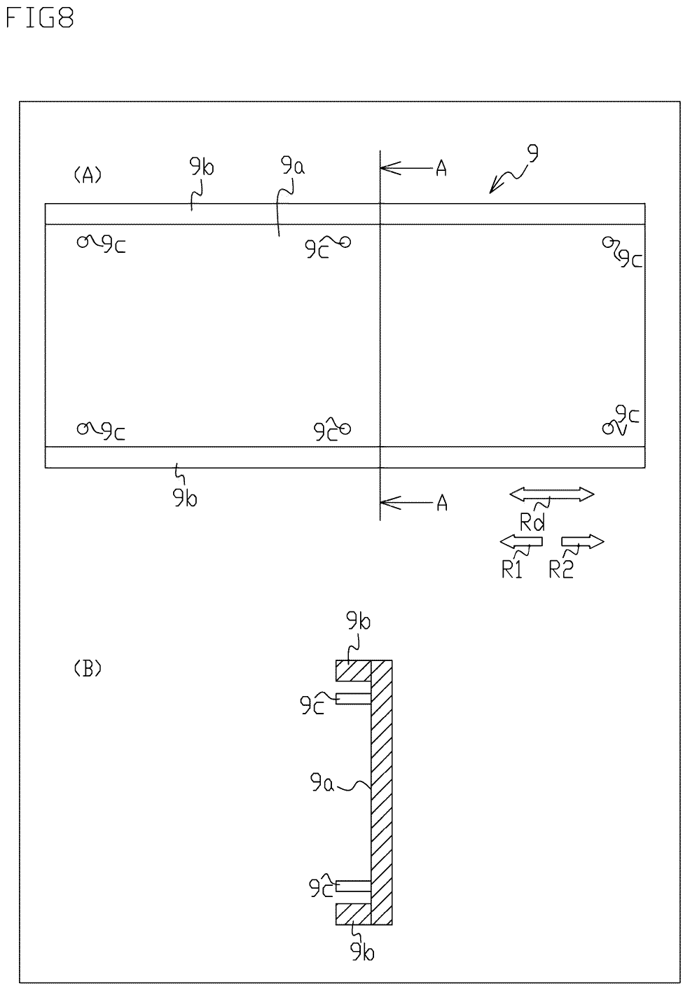

The position control member 9 is a member for controlling position of the rack member 11, and an end on the side of the second direction R2 is connected, via the connection member 13, with the structure connecting member 6a, and eventually with the shaft member 5. FIG. 8 (A) is a plan view showing a configuration of the position control member 9, and FIG. 8 (B) is an A-A sectional view of FIG. 8 (A). The position control member 9 is provided with a mounting surface 9a for mounting the rack member 11, side walls 9b formed at the both ends of the mounting surface 9a in the width direction, and a plurality of (in the present embodiment, six) bosses 9c formed on the mounting surface 9a. The width of the mounting surface 9a in a direction orthogonal to the displacement direction Rd is wider than the width of the rack member 11 in that direction, and the length of the mounting surface 9a in a direction along the displacement direction Rd is longer than the length of the rack member 11 in that direction. The two side walls 9b are attached, respectively, along the lengthwise direction of the mounting surface 9a (the displacement direction Rd), in a direction perpendicular to the mounting surface 9a. The six bosses 9c are attached, respectively, on the mounting surface 9a, in a direction perpendicular to the mounting surface 9a. In the present embodiment, the bosses 9c are configured to be positioned, at four corners of the mounting surface 9a, and at the center between the two bosses 9c and 9c along the displacement direction Rd. Each of the bosses 9c penetrates through each of the long holes 11a of the rack member 11, to be slidable in a lengthwise direction of the long hole 11a (oblique direction).

When the first rack 20 displaces in the first direction R1, that is the direction along the displacement direction Rd, as illustrated in FIG. 4, the position control member 9 controls the position of the rack member 11, so that the first rack 20 meshes with the pinion 12, and also, so that the second rack 21 separates from the pinion 12. Moreover, when the second rack 21 displaces in the second direction R2, that is the direction opposite to the first direction R1, as illustrated in FIG. 5, the position control member 9 controls the position of the rack member 11, so that the second rack 21 meshes with the pinion 12, and also, so that the first rack 20 separates from the pinion 12. Thus, associated with the displacement of the shaft member 5 in the displacement direction Rd, and by moving of the bosses 9c inside the respective long holes 11a in the oblique direction, the position control member 9 controls positions of the first rack 20 and the second rack 21 relative to the pinion 12.

Specifically, when each of the bosses 9c is at a position on the side of the second rack 21 and also on the side of the first direction R1 of the corresponding long hole 11a (a position as illustrated in FIG. 5), and accordingly when the position control member 9 displaces in the first direction R1, then, due to a repulsive force applied by the tooth surface 25b of the tooth 25 of the second rack 21 to the tooth 12a of the pinion 12, the position of the rack member 11 relative to the position control member 9 is determined to be a position as illustrated in FIG. 4, that is the position at which each of the bosses 9c is on the side of the first rack 20 and also on the side of the second direction R2 of the corresponding long hole 11a. Moreover, when each of the bosses 9c is at a position on the side of the first rack 20 and also on the side of the second direction R2 of the corresponding long hole 11a (a position as illustrated in FIG. 4), and accordingly when the position control member 9 displaces in the second direction R2, then, due to a repulsive force applied by the tooth surface 24b of the tooth 24 of the first rack 20 to the tooth 12a of the pinion 12, the position of the rack member 11 relative to the position control member 9 is determined to be a position as illustrated in FIG. 5, that is the position at which each of the bosses 9c is on the side of the second rack 21 and also on the side of the first direction R1 of the corresponding long hole 11a.

The cumulative displacement amount display member 10 displays the cumulative displacement amount measured from a rotation amount of the pinion 12. As illustrated in FIG. 3, the cumulative displacement amount display member 10 is provided with a display rotation shaft 31, a pointer 32, and a display plate 33. With the transmission of the rotation in the cumulative rotation direction R3, from the output shaft of the cumulative displacement gauge 3 to the display rotation shaft 31, the pointer 32 rotates in a counterclockwise direction. The display plate 33 displays three display ranges 33a, 33b, 33c, showing the cumulative displacement amount of the shaft member 5 in stages, within a display circle around which the pointer 32 rotates.

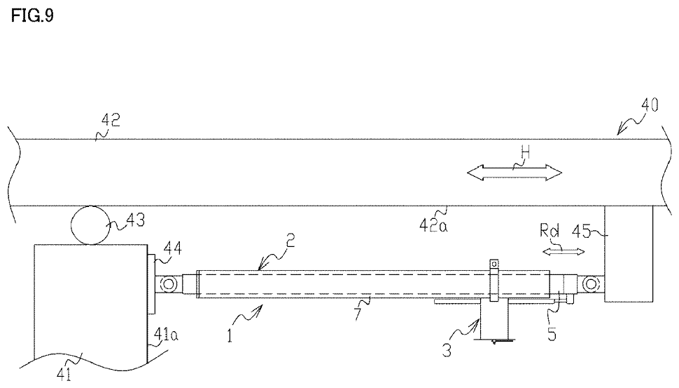

FIG. 9 is a view showing a state in which the vibration control damper 1 according to the embodiment is attached to a bridge. A bridge 40 is provided with a pier 41 standing from the ground (not shown), and a superstructure 42 placed on a top of the pier 41, and in a case where the superstructure 42 expands and/or shrinks due to temperature or deformation, for the purpose of preventing extra stress to the pier 41 and the superstructure 42, a movable bearing 43 is placed between the top of the pier 41 and the superstructure 42, in order to allow movement of the superstructure 42 in a lengthwise direction (in a right/left direction of FIG. 9). The superstructure 42 is placed above the top of the pier 41, passing over the pier 41. A pier-side bracket 44 is provided on an upper side surface 41a of the pier 41, and a superstructure-side bracket 45 is provided on a lower surface 42a of the superstructure 42. Note that, with reference to FIG. 9, although the vibration control damper 1 is extensively provided in a right/left direction of drawing sheet, it is also possible that the vibration control damper 1 is extensively provided in a front/back direction of drawing sheet, to be connected between the pier 41 and the superstructure 42.

The vibration control damper 1 is placed in a space partitioned by the pier 41 and the superstructure 42, along the lengthwise direction of the superstructure 42. Furthermore, with reference to the vibration control damper 1, the structure connecting member 6a at one end is rotatably connected with the superstructure-side bracket 45, and the structure connecting member 6b at another end is rotatably connected with the pier-side bracket 44 of the pier 41.

Next, actions of the vibration control damper 1 and the cumulative displacement gauge 3 in an event of earthquake will be explained. The vibration control damper 1 as illustrated in FIG. 9 absorbs vibration energy, which has been generated due to earthquake at an amount of relative displacement H between the pier 41 and the superstructure 42 in a horizontal direction, by plastic deformation of the shaft member 5 in a tension direction (the second direction R2) and in a compression direction (the first direction R1) of the axial direction (the displacement direction Rd), and performs vibration control in a direction along the lengthwise direction of the superstructure 42.

With reference to the cumulative displacement gauge 3 attached to the vibration control damper 1, in the event of earthquake, when the shaft member 5 displaces in the compression direction (the first direction R1), the position control member 9 and the rack member 11 also displace in the first direction R1. In this situation, when a position of the rack member 11 relative to the position control member 9 is at a position as illustrated in FIG. 4, that is, a position at which the first rack 20 meshes with the pinion 12, and also, at which the second rack 21 separates from the pinion 12, the position of the rack member 11 relative to the position control member 9 does not change, and the pinion 12 rotates in the cumulative rotation direction R3 by meshing of the pinion 12 with the first rack 20.

On the other hand, when a position of the rack member 11 relative to the position control member 9 is at a position as illustrated in FIG. 5, that is, at a position at which the second rack 21 meshes with the pinion 12, and also at which the first rack 20 separates from the pinion 12, the position control member 9 moves the rack member 11, so that the rack member 11 is positioned, from the position as illustrated in FIG. 5, to the position as illustrated in FIG. 4. Specifically, due to the repulsive force applied by the tooth surface 25b of the tooth 25 of the second rack 21, to the tooth 12a of the pinion 12, the position of the rack member 11 relative to the position control member 9 is determined to be the position at which each of the bosses 9c is on the side of the first rack 20 and also on the side of the second direction R2 of the corresponding long hole 11a. Thus, the position of the rack member 11 relative to the position control member 9 is determined to be the position at which the first rack 20 meshes with the pinion 12, and also at which the second rack 21 separates from the pinion 12, and the pinion 12 rotates in the cumulative rotation direction R3 by meshing with the first rack 20.

Moreover, with reference to the cumulative displacement gauge 3, in the event of earthquake, when the shaft member 5 displaces in the tension direction (the second direction R2), the position control member 9 and the rack member 11 also displace in the second direction R2. In this situation, when a position of the rack member 11 relative to the position control member 9 is at a position as illustrated in FIG. 5, that is, a position at which the second rack 21 meshes with the pinion 12, and also at which the first rack 20 separates from the pinion 12, the position of the rack member 11 relative to the position control member 9 does not change, and the pinion 12 rotates in the cumulative rotation direction R3 by meshing of the pinion 12 with the second rack 21.

On the other hand, when a position of the rack member 11 relative to the position control member 9 is at a position as illustrated in FIG. 4, that is, at a position at which the first rack 20 meshes with the pinion 12, and also at which the second rack 21 separates from the pinion 12, the position control member 9 moves the rack member 11, so that the rack member 11 is positioned, from the position as illustrated in FIG. 4, to the position as illustrated in FIG. 5. Specifically, due to the repulsive force applied by the tooth surface 24b of the tooth 24 of the first rack 20, to the tooth 12a of the pinion 12, the position of the rack member 11 relative to the position control member 9 is determined to be the position at which each of the bosses 9c is on the side of the second rack 21 and also on the side of the first direction R1 of the corresponding long hole 11a. Thus, the position of the rack member 11 relative to the position control member 9 is determined to be the position at which the second rack 21 meshes with the pinion 12, and also at which the first rack 20 separates from the pinion 12, and the pinion 12 rotates in the cumulative rotation direction R3 by meshing with the second rack 21.

As described above, in the event of earthquake, regardless of a case where the shaft member 5 displaces in the compression direction (the first direction R1), or in the tension direction (the second direction R2), the pinion 12 rotates in the cumulative rotation direction R3, that is, in a single direction. The rotation of the pinion 12 in the cumulative rotation direction R3 is transmitted, via the input shaft, gears in the gear box 26, and the output shaft, to the display rotation shaft 31 of the cumulative displacement amount display member 10, which causes rotation of the pointer 32 in the counterclockwise direction, and causes addition of the cumulative displacement amount displayed on the cumulative displacement amount display member 10.

According to the vibration control damper 1 and the cumulative displacement amount gauge 3 of the present embodiment, since it is possible to measure cumulative displacement amount by mechanical structure, even in a location where a commercial power source may not be used for a long period of time, or in a location where a replacement of power source, such as a battery, may not be made easily, because no electric power is required, it is possible to measure the cumulative displacement amount suitably. Moreover, because of non-complicated, simple structure of the cumulative displacement gauge 3, it is possible to remarkably minimize frequency of maintenance schedule, and furthermore, it is also possible to downsize the cumulative displacement gauge 3.

It should be noted that, although it has been explained that the cumulative displacement gauge 3 according to the present embodiment is attached to the damper body 2 of the vibration control damper 1 that absorbs the vibration energy, it is also possible to exhibit substantially the same effect, for example by mounting on a base isolation device and used as a device for displaying the cumulative displacement amount.

Moreover, it is also possible that the pinion 12 according to the present embodiment is further provided with a one-way clutch, which prevents rotation in a direction opposite to the cumulative rotation direction R3.

Moreover, according to the embodiment as described above, although the explanation has been made in a case where the vibration control damper 1 is an axial-yield type damper, it is also possible to achieve substantially the same effect, by using any one among a buckling restraining brace, a steel damper, a lead damper, a friction damper, a cylinder damper, an oil damper, a viscoelastic damper, a shear damper, a flexural yielding damper, a shear panel damper, a steel pipe damper, an unbonded brace, a corrugated steel panel damper, an inertial mass damper, and a rotative inertial mass damper.

Moreover, according to the present embodiment as described above, the first rack 20 and the second rack 21 are connected with each other by the first connection section 22 and the second connection section 23, but it is also possible that the first rack 20 and the second rack 21 are not connected with each other, provided that, when the first rack 20 displaces in the first direction R1, then, the first rack 20 meshes with the pinion 12, and also, the second rack 21 separates from the pinion 12, and furthermore, when the second rack displaces in the second direction R2, then, the second rack 21 meshes with the pinion 12, and also, the first rack 20 separates from the pinion 12.

Moreover, according to the present embodiment as described above, the explanation has been made with reference to an example in which the tooth surfaces 24a and 24b of the tooth 24, and the tooth surfaces 25a and 25b of the tooth 25, are in different shapes, but it is also possible that the tooth surfaces 24a and 24b of the tooth 24, and the tooth surfaces 25a and 25b of the tooth 25, are not in different shapes, provided that, when the first rack 20 displaces in the first direction R1, then, the first rack 20 meshes with the pinion 12, and also, the second rack 21 separates from the pinion 12, and furthermore, when the second rack displaces in the second direction R2, then, the second rack 21 meshes with the pinion 12, and also, the first rack 20 separates from the pinion 12.

Moreover, according to the present embodiment as described above, the explanation has been made with reference to an example in which, with regard to the tooth surface 24b of the tooth 24, the tooth surface 25b of the tooth 25, and the long hole 11a, each of the inclination angles is the same, but it is also possible that, the inclination angle of the tooth surface 24b of the tooth 24 and that of the tooth surface 25b of the tooth 25 is different from the inclination angle of the long hole 11a.

Moreover, according to the present embodiment as described above, the explanation has been made with reference to an example in which, as an output member for outputting the cumulative displacement amount measured from the rotation amount of the pinion 12, the cumulative displacement amount display member 10, for displaying the cumulative displacement amount, is used, but it is also possible to have a configuration provided with a member, other than the display member, which outputs the cumulative displacement amount. For example, it is also possible to have a configuration to transmit the cumulative displacement amount by attaching a transmitting member using a solar cell, or the like, is used as a power source.

### REFERENCE SIGNS LIST

1: Vibration control damper; 2: Damper body; 3: Cumulative displacement gauge; 5: Shaft member; 6a, 6b: Structure connecting members; 7: Stiffening member; 8: Rack-and-pinion section; 9: Position control member; 9a: Mounting surface; 9b: Side walls; 9c: Bosses; 10: Cumulative displacement amount display member; 11: Rack member; 11a: Long holes; 12: Pinion; 13: Connection member; 14: Case; 16: Fixing belt; 20: First rack; 21: Second rack; 22: First connection section; 23: Second connection section; 12a, 24, 25: Tooth; 24a, 24b, 25a, 25b: Tooth surface; 26: Gear box; 31: Display rotation shaft; 32: Pointer; 33: Display plate; 40: Bridge; 41: Pier; 42: Superstructure; 43: Movable bearing; 44: Pier-side bracket; 45: Superstructure-side bracket.

1. A cumulative displacement gauge for measuring a cumulative displacement amount of a second member relative to a first member, comprising:
a first rack attached to the second member and extending in a displacement direction in which the second member displaces, the first rack having teeth whose tooth surface in a first direction along the displacement direction is a concave surface and whose tooth surface in a second direction that is a direction opposite to the first direction is an inclined surface having a predetermined angle relative to the displacement direction;
a second rack attached to the second member with having a predetermined distance from the first member and extending in the displacement direction, the second rack having teeth whose tooth surface in the first direction is an inclined surface having a predetermined angle relative to the displacement direction and whose tooth surface in the second direction is a concave surface;
a pinion positioned between the first rack and the second rack, and rotatably supported by the first member, the pinion having odd number of teeth; a position control member for controlling positions of the first rack and second rack relative to the pinion; and
an output member for outputting the cumulative displacement amount measured from a rotation amount of the pinion, wherein,
when the second member is displaced in the first direction while the tooth surface of the concave surface of the second rack meshes with the teeth of the pinion, the teeth of the pinion that have meshed with the tooth surface of the concave surface of the second rack are repelled by the tooth surface of the inclined surface of the teeth in the second direction of the second rack, and the second rack is separated from the pinion, and the positions of the first rack and the second rack relative to the pinion are controlled by the position control member so that the tooth surface of the concave surface of the first rack meshes with the tooth of the pinion, and the first rack causes rotation of the pinion in a cumulative rotation direction, and
when the second member is displaced in the second direction while the tooth surface of the concave surface of the first rack meshes with the teeth of the pinion, the teeth of the pinion that have meshed with the tooth surface of the concave surface of the first rack are repelled by the tooth surface of the inclined surface of the teeth in the first direction of the first rack, and the first rack is separated from the pinion, and the positions of the first rack and the second rack relative to the pinion are controlled by the position control member so that the tooth surface of the concave surface of the second rack meshes with the tooth of the pinion, and the second rack causes rotation of the pinion in the cumulative rotation direction.

2-4. (canceled)

5. The cumulative displacement gauge according to claim 17, wherein,
the first rack and the second rack respectively include a plurality of long holes inclined relative to the displacement direction; and
the position control member includes a plurality of bosses respectively inserted into each of the long holes, and controls a position of the first rack and a position of the second rack respectively relative to the pinion by movement of the bosses inside the long holes associated with displacement of the second member in the displacement direction.

6. (canceled)

7. The cumulative displacement gauge according to claim 1, wherein,
the output member is a display member for displaying the cumulative displacement amount.

8. The cumulative displacement gauge according to claim 1, further comprising:
a first connection section for connecting one end in the displacement direction of the first rack with one end in the displacement direction of the second rack; and
a second connection section for connecting another end in the displacement direction of the first rack with another end in the displacement direction of the second rack.

9. The cumulative displacement gauge according to claim 1, wherein,
the first member is a stiffening member of a vibration control damper for dampening vibration of a structure; and
the second member is a shaft member of the vibration control damper.

10. A vibration control damper for dampening vibration of a structure, comprising:
a shaft member displaced by the vibration;
a stiffening member for preventing buckling of the shaft member; and
the cumulative displacement gauge according to claim 1 for measuring displacement of the shaft member relative to the stiffening member.

11-12. (canceled)

13. The vibration control damper according to claim 10, wherein,
the first rack and the second rack of the cumulative displacement gauge respectively include a plurality of long holes inclined relative to the displacement direction; and
the position control member of the cumulative displacement gauge includes a plurality of bosses respectively inserted into each of the long holes, and controls a position of the first rack and a position of the second rack respectively relative to the pinion by movement of the bosses inside the long holes associated with displacement of the second member in the displacement direction.

14. (canceled)

15. The vibration control damper according to claim 10, wherein,
the output member of the cumulative displacement gauge is a display member for displaying the cumulative displacement amount.

16. The vibration control damper according to claim 10, further comprising:
a first connection section for connecting one end in the displacement direction of the first rack with one end in the displacement direction of the second rack of the cumulative displacement gauge; and
a second connection section for connecting another end in the displacement direction of the first rack with another end in the displacement direction of the second rack of the cumulative displacement gauge.

17. The cumulative displacement gauge according to claim 1, wherein,
the first rack and the second rack are respectively attached to the second member via the position control member.

18. The cumulative displacement gauge according to claim 5, wherein,
an inclination angle of the tooth surface of the inclined surface of the first rack relative to the displacement direction, an inclination angle of the tooth surface of the inclined surface of the second rack relative to the displacement direction, and an inclination angle of the long hole relative to the displacement direction are within a range from 36 degrees to 54 degrees.

19. The cumulative displacement gauge according to claim 1, wherein,
the pinion includes a one-way clutch, which prevents rotation in a direction opposite to the cumulative rotation direction.

20. The vibration control damper according to claim 13, wherein,
an inclination angle of the tooth surface of the inclined surface of the first rack relative to the displacement direction, an inclination angle of the tooth surface of the inclined surface of the second rack relative to the displacement direction, and an inclination angle of the long hole relative to the displacement direction are within a range from 36 degrees to 54 degrees.

21. The vibration control damper according to claim 10, wherein,
the pinion includes a one-way clutch, which prevents rotation in a direction opposite to the cumulative rotation direction.
